(19) United States
(12) Patent Application Publication
(10) Pub. No.: US 2013/0070339 A1
(43) Pub. Date: Mar. 21, 2013

(54) METHOD AND DEVICE FOR IMAGE STABILIZATION IN AN OPTICAL OBSERVATION OR MEASUREMENT INSTRUMENT

(71) Applicant: CARL ZEISS AG, Oberkochen (DE)

(72) Inventor: Marco Pretorius, Oberkochen (DE)

(73) Assignee: CARL ZEISS AG, Oberkochen (DE)

(21) Appl. No.: 13/621,605

(22) Filed: Sep. 17, 2012

(30) Foreign Application Priority Data
Sep. 15, 2011 (DE) 10 2011 053 630.2

(51) Int. Cl. G02B 27/64

(52) U.S. Cl. 359/557

(57) ABSTRACT

A method is provided for image stabilization in an optical instrument (1, 101) with observation optics (3) that have an optical axis (OA) and at least one optical element with adjustable refractive power (7, 7A, 7B, 177), an unintended movement taking place between the observation optics (3) and an observation object (4) along the optical axis (OA). The unintended movement along the optical axis (OA) is determined and on the basis of the movement determined, at least one control variable for the adjustable optical element (7, 7A, 7B, 177) is determined, which represents the refractive power of the optical element with adjustable refractive power (7, 7A, 7B, 177) necessary for optical compensation for the movement along the optical axis (OA). An adjustment of the optical element with adjustable refractive power (7, 7A, 7B, 177) is carried out on the basis of the control variable.

### BACKGROUND OF THE INVENTION

1. Field of the Invention

The present invention relates to a method for image stabilization in an optical observation instrument or an optical measurement instrument comprising observation optics, which are subject to movement along their optical axis. The invention furthermore relates to a device for image stabilization in an optical observation instrument or an optical measurement instrument. The invention furthermore relates to an optical observation or measurement instrument.

2. Description of the Related Art

During the observation of observation objects by means of optical observation instruments, the observation object must be kept stationary in order to avoid blurring in the images. This applies in particular when electronic imaging is intended to be carried out with the optical observation instrument. Movements of the observation optics which take place more rapidly than the imaging lead to blurring in the recorded image, which depending on the situation may be highly problematic. Unintended movements of the observation optics may for example result from hand trembling in the case of hand-held observation and/or recording instruments, owing to which a stand is generally used for prolonged exposure times. Nevertheless, vibrations in mechanical holding devices of an optical observation instrument can also lead to blurring in the image. When close objects are observed or recorded, for example with microscopes or macro-objectives, blurring in the image occurs not only because of movements of the observation optics perpendicular to the optical axis but also due to unintended movements parallel to the optical axis, i.e. in the direction towards the object and away from the object.

For example, operation microscopes with a magnification of up to 30 times are typically used in neurosurgery, these being suspended from a stand. As a mechanical structure, however, the stand is not infinitely rigid and therefore exhibits a certain degree of deformation under loading. Making the stand infinitely rigid is not technically possible. Furthermore, a high rigidity also entails a very high intrinsic weight. The finite rigidity makes the stand a vibratable system. Owing to impacts or a small periodic force, the stand may be excited in vibrations. If the stand vibrates, then the image quality of the operation microscope is significantly influenced, which entails disadvantages particularly in neurosurgical operations. Similar problems also arise with optical measuring instruments.

It has therefore been proposed, for example for operation microscopes, to equip stands with vibration damping systems. These typically comprise actuators which can exert a force on an element of the stand so as to counteract stand vibrations. An example of such a stand is described in US 2009/002066 A1.

Furthermore, image stabilization systems are known in which lateral movements or tilts of the observation optics relative to an observation object to be observed or recorded are compensated for by displacing a lens or lens group in a direction perpendicular to the optical axis. Optical observation instruments having such image stabilization systems are described, for example in U.S. Pat. No. 5,270,857 and U.S. Pat. No. 5,477,297.

Besides this, there are image stabilization systems in which movements perpendicular to the optical axis are optically compensated for by variable prisms or variable wedge-shaped elements instead of by disposable lenses. Examples of such systems are known from U.S. Pat. No. 5,140,462, U.S. Pat. No. 5,280,387, U.S. Pat. No. 3,475,074 and U.S. Pat. No. 3,942,862.

From U.S. Pat. No. 4,881,800 and U.S. Pat. No. 6,653,611, image stabilization systems are known which comprise mirrors mounted so that they can be moved about one or two axes, with corresponding drive actuators, by which image displacements perpendicular to the optical axis and tilts can be compensated for.

All these systems make it possible to compensate for image displacements, i.e. movements perpendicular to the optical axis, or tilts of the observation optics in relation to the observation object. Image stabilization in a direction parallel to the optical axis, i.e. compensation for movements parallel to the optical axis, is not however possible with the systems mentioned.

In the case of movements parallel to the optical axis, particularly for observations of close observation objects, a sharp image cannot always be ensured. From photography, for example, it is known that objectives having active image stabilization only lead to effective stabilization for distant objects, while in the near field and particularly in the macro range the stabilizing effect rapidly deteriorates. One reason for this is that the natural depth of focus in the near setting decreases quadratically with the object distance and, with corresponding proximity of the object, it can be correspondingly less than the amplitude of the unintended movement parallel to the optical axis. This problem is also known in the case of reverberating stands, on which microscopic devices such as for instance operation microscopes are fastened. Although the depth of focus can generally be increased by reducing the aperture, this entails a loss of light which is not always acceptable.

In relation to the prior art mentioned above, it is an object of the present invention to provide a method and a device for image stabilization, which make it possible to ensure a sharp image even in the event of unintended movements of the observation optics parallel to the optical axis. It is also an object to provide an advantageous optical observation instrument.

### SUMMARY OF THE INVENTION

In the method according to the invention for image stabilization in an optical observation instrument or measurement instrument comprising observation optics which have an optical axis and at least one optical element with adjustable refractive power, an unintended movement taking place between the observation optics and an observation object along the optical axis, optical compensation for the movement of the observation optics is carried out along the optical axis. The movement in this case may be caused by the observation optics, the observation object or both. However, it is usually attributable to a movement of the observation optics.

The optical compensation is carried out in that the unintended movement along the optical axis is determined. On the basis of the movement determined, at least one control variable for the adjustable optical element is then determined, which represents the refractive power of the at least one optical element with adjustable refractive power necessary for optical compensation for the unintended movement along the optical axis. An adjustment of the at least one optical element with adjustable refractive power is then carried out on the basis of the at least one control variable. The adjustment of the refractive power may in this case be carried out with the aid of a control movement, with the aid of the adaptation of electrical signals, with the aid of the adaptation of a pressure, etc. The control variables used for this may, for example, be calculated with the aid of a formula. As an alternative, it is also possible to provide a look-up table in which particular control variables are assigned to particular movements. The determination of the control variable necessary for the optical compensation for the movement can then be carried out with the aid of a look-up in the table as soon as the movement has been determined.

If the unintended movement results from a movement of the observation optics, then for example the movement speed of the observation optics or the acceleration of the observation optics may be recorded in order to determine the movement of the observation optics. It is, however, also possible to determine movement variables such as the movement speed or the acceleration on the basis of repeatedly performed position measurements. The movement of the observation object can be determined from the movement speed, or in particular the acceleration. Prediction of future positions is also possible in this case, in which case it is particularly advantageous for the acceleration of the observation optics to be recorded.

By means of optical compensation for movements along the optical axis of the observation optics, which can be carried out by means of adjusting the refractive power of an optical element, with the method according to the invention it is possible to compensate for the influence of movements along the optical axis on the image sharpness so that, for example, a sharp image can be ensured even in the event of vibrations of the observation optics parallel to the optical axis.

In the method according to the invention, the determination of the movement, the determination of the at least one control variable and the adjustment of the at least one optical element with adjustable refractive power may be carried out repeatedly, in particular continuously at short time intervals. The length of the time intervals may in this case be determined by a time variable such as, for instance, the period of a vibration. Repeated recording of the movement, determination of the control variable and adjustment of the optical element therefore make it possible to compensate for persistent movements such as, for example, movements of the observation optics along the optical axis. Nevertheless, compensation for vibrations of the observation object in the direction of the optical axis may also be carried out in this way.

The adjustment of the refractive power of the optical element may, for example, be carried out by control movements. In this case, however, accelerations may occur which can in turn lead to vibrations of the observation optics. It is therefore advantageous for the smallest possible accelerations of the moved elements to occur during the control movements. In order to achieve this, for the case in which the at least one optical element with adjustable refractive power executes a control movement during the adjustment of the refractive power, smoothing of the at least one control variable may be carried out which leads to a minimization of the acceleration forces occurring during the control movement. Such smoothing may, for example, be carried out in that a parameterized function is fitted with the aid of the at least one repeatedly determined control variable, and the adjustment of the at least one optical element with adjustable refractive power is carried out with the aid of the parameterized function obtained on the basis of the at least one control variable. For example, a harmonic vibration with frequency and amplitude as parameters may be used as the parametric function. Particularly in the case of compensating for vibrations, this function models the movement process to be compensated for, so that accelerations in the scope of the control movement can be minimized.

Besides attenuating the effects on the image of movements, for example vibrations, along the optical axis, i.e. reaction to the effects after they occur, the effects to be expected may also be already counteracted at the time when they occur. To this end, in a refinement of the method according to the invention, position changes to be expected between the observation optics and the observation object are precalculated with the aid of the determined movement along the optical axis. The at least one control variable is then determined with a view to the position changes to be expected. With the aid of the control variable determined in this way, it is for example possible to compensate for the effect of a vibration excursion on the image of the observation object by a corresponding prompt adaptation of the refractive power already at the time when it occurs.

In an advantageous configuration of the method according to the invention, the optical element with adjustable refractive power comprises at least two optical subelements, the refractive powers of which can be adjusted independently of one another. The optical compensation for the movement along the optical axis is then carried out by determining at least one control variable for each of the optical subelements with adjustable refractive power on the basis of the movement determined, and an adjustment of the refractive powers of the optical subelements is carried out on the basis of the respective control variable or the respective control variables. This configuration of the method makes it possible to adapt the focal length of the observation optics to the recorded movement by means of one subelement and to keep the back focal distance of the observation optics, i.e. the distance of the image from the rearmost optical surface of the observation device, constant by means of the other subelement. It is therefore possible to keep both the image distance, i.e. the distance between the image generated by the observation optics and the image-side principal plane along the optical axis, as well as the image size in an adjustment range of occurring object distances constant, and therefore avoid blurring due to movement. It should be pointed out here that splitting of the two optical subelements such that one is used as a variator for adapting the focal length and the other as a compensator to keep the back focal distance constant, is not compulsory. The two functions may respectively be carried out partially by two optical subelements. Furthermore, it is also possible to use more than two optical subelements with adjustable refractive power in order to achieve this purpose.

If, in the scope of the method according to the invention, determination and compensation for an intended movement between the observation optics and the observation object perpendicularly to the optical axis of the observation optics are furthermore carried out, in particular optical compensation, then the method according to the invention allows three-dimensional image stabilization, i.e. compensation for movements in all spatial directions, that is to say both parallel to the optical axis of the observation optics and perpendicular thereto.

According to a second aspect of the invention, a device for image stabilization in an optical observation instrument is provided. The optical observation instrument is equipped with observation optics, which have an optical axis, an unintended movement being capable of taking place between the observation optics and an observation object along the optical axis. The image stabilization device comprises an optical element with adjustable refractive power which is to be arranged in the beam path of the observation optics and is capable of optically compensating for an unintended movement along the optical axis with the aid of a change in its refractive power in response to at least one control signal. The adjustment of the refractive power may in this case be induced by a control movement, by the adaptation of an electrical voltage, the adaptation of a pressure etc. In the beam path of the observation optics is in this case intended to mean that the optical element may lie in the observation optics, before the observation optics or after the observation optics.

The device according to the invention furthermore comprises a movement sensor which records the movement between the observation optics and observation object along the optical axis and outputs a movement signal representing the movement. If the unintended movement is due to a movement of the observation optics, the movement sensor may for example be arranged on or in the observation optics. Acceleration sensors may in particular be envisaged. Movement sensors which are arranged remotely from the observation optics, and which can contactlessly detect a movement of the observation optics or of the observation object, may however also be envisaged. Here for example, optical or radio-based position measurement devices may be considered.

The device according to the invention furthermore comprises a control unit which is connected to the movement sensor in order to receive the movement signal and is connected to the at least one optical element with adjustable refractive power in order to output the at least one control signal. The at least one control signal represents the refractive power of the at least one optical element with adjustable refractive power, which is necessary for optical compensation for the unintended movement the between observation optics and observation object along the optical axis. The control unit determines the at least one control signal on the basis of the movement determined.

The device according to the invention makes it possible to carry out the method according to the invention, and therefore to achieve the properties and advantages described in relation to the method according to the invention. Reference is therefore made to the properties and advantages described in relation to the method in order to avoid repetition.

In a specific configuration of the device according to the invention, the optical element with adjustable refractive power may comprise at least two freeform elements which can be moved relative to one another in a direction perpendicular to the optical axis. The at least one control signal represents in this case the position of the freeform elements perpendicularly to the optical axis. By a relative displacement of the two freeform elements, it is possible to adjust the refractive power of the optical element formed by the two freeform elements. Use of the freeform elements makes it possible to carry out the refractive power modifications which are necessary for compensating for the movement the between the observation optics and observation object, with very small control movements which can be executed with small forces—and therefore with small accelerations—and sufficiently rapidly. Freeform elements such as may be used in the device according to the invention, and the properties thereof, are described for example in U.S. Pat. No. 3,305,294. With respect to the structure and the properties of freeform elements, reference is made to this document.

In a second specific configuration of the device according to the invention, the optical element with adjustable refractive power comprises a liquid crystal lens. The at least one control signal then represents a voltage to be applied to the liquid crystal lens. A liquid crystal lens is described, for example, in US 2009/0219475 A1. In relation to the structure and properties of liquid crystal lenses, reference is therefore made to this document. The use of a liquid crystal lens makes it possible to optically compensate for the refractive power of the optical element and therefore the compensation for movements between the observation optics and observation object along the optical axis, without optical elements or components thereof having to be accelerated.

In yet another specific configuration of the device according to the invention, the optical element with adjustable refractive power comprises a membrane lens. The at least one control signal then represents a pressure to be set up in the membrane lens. Membrane lenses are described, for example, in DE 197 10 668 A1. In relation to the structure and properties of membrane lenses, reference is therefore made to this document.

In the device according to the invention, the optical element with adjustable refractive power to be arranged in the observation optics may comprise at least two optical subelements, the refractive powers of which can be adjusted independently of one another. As optical subelements, combinations of freeform elements, liquid crystal lenses and membrane lenses may be envisaged in this case. The optical subelements may in this case respectively be of the same type, (for example two optical subelements each comprising two freeform elements, two liquid crystal lenses, etc.) or different (one optical subelement comprising two freeform elements and one membrane lens, one membrane lens and one liquid crystal lens, etc.). Owing to the fact that the optical element in this configuration comprises at least two optical subelements, the refractive powers of which can be adjusted independently of one another, by simultaneous adaptation of two refractive powers it is also possible to ensure a constant image size besides compensating for the defocusing caused by the movement between the observation optics and the observation object parallel to the optical axis.

The device according to the invention may furthermore comprise at least one instrument to be arranged in the beam path of the observation optics to compensate for an unintended movement the between observation optics and the observation object perpendicularly to the optical axis. In this refinement of the device according to the invention, compensation for three-dimensional movements of the observation optics is possible. The control unit may in this case control both the compensation for the movement perpendicular to the optical axis and the compensation for the movement parallel to the optical axis. It is, however, also possible to provide separate control units, one control unit compensating for the movement along the optical axis and the other compensating for the movement perpendicular to the optical axis. The control unit, which controls the compensation for the movement perpendicular to the optical axis, may itself in turn be divided into two control units, each of which compensates for the compensation of mutually perpendicular movements in a plane perpendicular to the optical axis.

According to a third aspect of the invention, an optical observation instrument or an optical measurement instrument is provided, which comprises observation optics and an image stabilization device according to the invention. The optical observation instrument may, in particular, be a medical optical observation instrument such as, for instance, an operation microscope.

Other features, properties and advantages of the present invention may be found in the following description of exemplary embodiments with reference to the appended figures.

### BRIEF DESCRIPTION OF THE DRAWINGS

FIG. 1 shows an optical observation instrument according to the invention in a highly schematized representation.

FIG. 2 shows a detail of FIG. 1.

FIG. 3 shows an alternative embodiment of the optical observation instrument of FIG. 1.

FIG. 4 shows a further exemplary embodiment of an optical observation instrument according to the invention.

FIG. 5 shows the optical observation instrument of FIG. 3 on a stand.

### DETAILED DESCRIPTION OF THE PREFERRED EMBODIMENTS

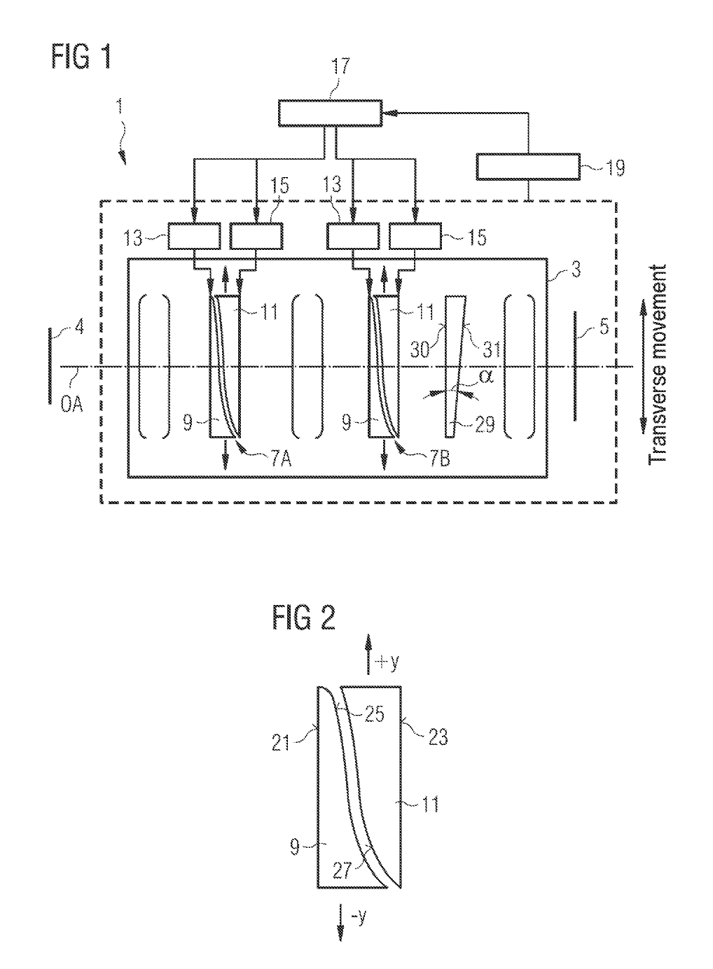

A first exemplary embodiment of an optical observation instrument according to the invention will be described below with reference to FIG. 1. The figure shows in a highly schematized way a camera comprising a macro-objective 3 as observation optics and an image sensor 5, onto which the observation object 4 is imaged with the aid of the macro-objective 3. The camera 1 furthermore comprises an image stabilization device, with which unintended movements between the camera 1—and therefore the macro-objective 3—on the one hand and the observation object 4 on the other hand along the optical axis OA of the objective can be optically compensated for, i.e. compensated for by optical means. Movements to be compensated for may for example be caused by hand trembling or, if the camera 1 is mounted on a stand, by stand vibrations. It is, however, also possible to compensate for movements of the observation object 4.

The image stabilization device comprises an optical element with adjustable refractive power 7A, 7B which is to be arranged in the beam path of the observation optics and is capable of optically compensating for a movement between the observation optics 3 and the observation object 4 along the optical axis OA with the aid of a change in its refractive power in response to at least one control signal. In the present exemplary embodiment, the optical element with adjustable refractive power is arranged in the macro-objective 3 and comprises two separate subelements 7A, 7B, the refractive power of which can respectively be adjusted independently of one another. The two optical subelements 7A, 7B are respectively composed of two freeform elements 9, 11 which can be moved relative to one another perpendicularly to the optical axis. Each freeform element is connected to an actuator 13, 15, the actuators 13, 15 and the associated freeform elements 9, 11 respectively being displaceable in opposite directions from a resting position.

The actuators 13, 15 are connected to a control unit 17 which is in turn connected to a movement sensor 19, which in the present exemplary embodiment records the movement of the observation optics 3 at least along the optical axis OA and outputs a movement signal representing this movement. The movement sensor may, however, also be configured in particular so that it records a three-dimensional movement of the observation optics 3 or the camera 1, to which the optics 3 are firmly connected. The movement sensor may be a sensor firmly connected to the camera 1 or the macro-objective 3, for instance an acceleration sensor, or a sensor arranged remotely from the camera 1 and the macro-objective 3. Such a remotely arranged sensor may, for example, be based on triangulation by means of time-of-flight signals. To this end, a transponder may optionally be applied on the camera 1 or on the macro-objective 3. An acceleration sensor connected to the camera 1 or the observation optics 3 is expedient when the movement between the observation optics 3 and the observation object 4 is due to a movement of the observation optics 3, since in this way the absolute movement of the observation optics 3 is recorded. If a distance sensor is used instead of the acceleration sensor, it is furthermore also possible to compensate for a relative movement between the observation optics and the observation object, which is at least partially attributable to the observation object.

By means of the movement sensor 19, in the present exemplary embodiment the movements of the macro-objective 3 are continuously recorded at least in the direction parallel to the optical axis OA and the corresponding movement signal is output to the control unit 17. Here, continuous recording is also intended to mean quasi-continuous recording at short time intervals, as is conventional in digital systems. If quasi-continuous recording is employed, the clock cycle is to be sufficiently short, for example at least every 15 ms, more preferably every 10 ms. A suitable clock cycle also depends on the intended use of the observation optics 3. If for example recordings with an image repetition rate of 24 Hz corresponding to the cinematic standard are intended to be recorded, at most 41.6 ms are available for each exposure. Movements which lead to blurring in the recorded image during these 41.6 ms must within this time cause deflection of the objective 3 which is greater than the depth of focus of the objective 3. In order to be able to record and parameterize such a movement with the movement sensor in the case of time-discrete quasi-continuous position or acceleration determination, the clock rate for this recording must be shorter than the exposure lasting 41.6 ms. A clock cycle of 10 ms or faster for determining the position or the acceleration is therefore advantageous. For longer exposure times, on the other hand, slower movements may already lead to blurring in the image. If only slower movements are encountered, the position or the acceleration may be recorded with a lower frequency. Overall, the clock frequency to be used for quasi-continuous recording of the acceleration or the position of the observation optics 3 thus depends on the one hand on the selected exposure time, a shorter exposure time implying a higher clock frequency, and on the other hand on the speed of the movement along the optical axis OA, in which case a faster movement again implies a higher clock frequency. The clock frequency actually used may then, for example, be determined by determining the minimum clock frequency required with a view to the exposure time, determining the minimum clock frequency necessary with a view to the speed of the movement to be recorded, and then using the higher of the two clock frequencies.

The control unit 17 receives the movement signals from the movement sensor 19 and determines therefrom at least one control signal for the optical element with adjustable refractive power. In the exemplary embodiment shown in FIG. 1, the control unit 17 determines 4 control signals overall, namely one for each actuator 13, 15. The total set of the control signals represents the refractive powers which are intended to be adjusted at the optical subelements 7A, 7B of the optical element with adjustable refractive power. The signals are finally output to the actuators 13, 15, which adjust the respective positions of the freeform elements with the aid of the signals in order to achieve the required refractive power in the two optical subelements 7A, 7B. The adjustment of the refractive power in the two optical components (subelements) 7A, 7B is thus carried out by mutual displacement of the freeform elements 9, 11 in a direction perpendicular to the optical axis OA. The way in which the refractive power modification is achieved will be explained in more detail below with reference to FIG. 2.

The freeform elements 9, 11 of the optical components 74A, 7B each have a plane face 21, 23 and a freeform face 25, 27. The freeform faces 25, 27 may, for example, be described by a Taylor polynomial in two variables, which satisfy certain differential equations. In this way, a rotationally symmetrical optical effect can be achieved, which can be used to provide a lens with variable refractive power. Details regarding the construction and the structure of such freeform elements are described in U.S. Pat. No. 3,305,294, to which reference is made in this context.

In the simplest case, in order to vary the refractive power, precisely two elements are displaced transversely to the optical system axis (one element in the +y direction and the other in the −y direction, both counter to one another by the same amounts) and the two elements each consist of one planar side 21, and one freeform side 25, 27, which extend exactly mirror-symmetrically with respect to one another in a neutral position so that the two elements in a neutral position are equivalent to a plane-parallel plate. Pure defocusing can be brought about according to U.S. Pat. No. 3,305,294 if the freeform face can be described by the following 3rd order polynomial:

$$z ( x , y ) = k \cdot ( {x}^{2} \cdot y + \frac{{y}^{3}}{3} ) \qquad ( A1 )$$

Here, it is assumed that the lateral displacement of the freeform elements 9, 11 takes place along the y axis, which is thereby defined. If the displacement is intended to take place along the x axis, the roles of x and y are correspondingly to be interchanged in the equation above.

For ray bundles incident parallel to the axis, lateral displacement of the two freeform elements 9, 11 by a distance s therefore causes a change of the wavefront according to the equation:

$$Δ W ( x , y ) = k \cdot ( 2 \cdot s \cdot ( {x}^{2} + {y}^{2} ) + 2 \cdot \frac{{s}^{3}}{3} ) \qquad ( A2 )$$

i.e. a change of the focal position by modification of the parallel wavefront component plus a piston term, the latter having no effect on the imaging properties precisely when the refractive power-variable element lies in the infinite beam path. It is therefore advantageous to arrange optical components 7A, 7B in the parallel beam path of the observation optics.

It is possible for the two freeform elements 9, 11 moved relative to one another to be oriented in such a way that the two freeform faces 25, 27 face one another. In this case, it is particularly simple to carry out the adjustment of the neutral position by reducing the distance between the two elements until the two freeform elements 9, 11 touch. In this position, centering automatically takes place. Subsequently, the distance in the axial direction may be increased again precisely until the two freeform elements 9, 11 just do not touch during the lateral movement during functional operation.

It is, however, also possible to orientate the two freeform elements 9, 11 in such a way that the freeform faces 25, 27 face away from one another. In this way, the distance between the freeform elements 9, 11, which then oppose one another at the plane faces 21, 23, can be kept to a minimum, which has been found to be advantageous for the imaging quality in particular with larger field and aperture angles at the junction face between the two freeform elements 9, 11.

It is also possible for the freeform faces 25, 27 to comprise additional terms of higher order in order to influence the image defects. For example, a term of the form

$$z ( x , y ) = k \cdot ( y \cdot {x}^{4} + \frac{2}{3} \cdot ( {x}^{2} \cdot {y}^{3} ) + \frac{{y}^{5}}{3} ) \qquad ( A3 )$$

would predominantly influence the spherical aberration and could, for example for applications in the field of microscopy, therefore help to correct the spherical aberration which occurs during focusing at a different sample depth. Partial or full compensation for the spherical aberration caused by the thickness change of the freeform element (piston term) in the convergent beam path may also be carried out in this way.

Furthermore, it is possible to represent an optical element with variable refractive power substantially equivalent to the teaching described above, in which two freeform faces are described, for example, to lowest order by an equation of the form

z(x,y)=A·(x³+y³) (A4)

and the relative movement of the elements with respect to one another takes place perpendicularly to the optical system axis along a straight line extending at 45° relative to the x and y axes. The constant A is in this case a free constant, which describes the maximum profile depth of the freeform face and therefore the refractive power change per path length. This description is not an independent solution, but essentially only an alternative representation (cf. Lohmann in Appl. Opt. Vol 9, No 7, 1970, pages 1669 to 1671).

Furthermore, it is also possible for the opposing faces of the freeform elements 9, 11 not to be formed in a planar fashion, but also to have an active shape. For example, symmetrical division of the surface profile according to the formula above on the front and rear faces of a freeform element 9, 11 could have the effect that the profile depths on each face remain sufficiently small so that, for example, photolithographic production of the freeform elements, which typically only allows maximum profile depths in the range <10-30 μm, is facilitated. In order to prevent or reduce reflections or to facilitate producibility, a refractive power-free meniscus effect may also be superimposed, i.e. the same spherical curvatures of the face are superimposed on the freeform active profile on the front and rear sides of each element.

It is known that the desired variably adjustable phase function may also be brought about by diffractive elements which can be displaced laterally with respect to one another (cf. Barton et al., Opt. Lett., Vol. 25, No. 1, (2000)). The advantage of a diffractive optical element is the facilitated producibility by photolithographic processes or by replicative production methods. Use may firstly be considered in particular for spectrally narrowband applications. Since stray light may occur in undesired diffraction orders in the case of diffractive variolenses, suitable stops are in each case to be provided which prevent spurious light from passing further through the optical system.

The two optical components with variable refractive power 7A, 7B, which are provided in the exemplary embodiment shown in FIG. 1, are used to simultaneously keep the image size and the position of the image plane constant in the system by suitable refractive power adaptations, while the objective 3 moves relative to the observation object 4 in the longitudinal direction. In the case of precisely two optical components with variable refractive power 7A, 7B, two degrees of freedom are available for simultaneously fulfilling these two conditions, there generally being precisely one solution for the required refractive power changes Δφ1 and Δφ2 of the two optical components with variable refractive power 7A, 7B.

The necessary refractive power changes of the at least two optical components with variable refractive power 7A, 7B generally depend, however, on the optical structure of the basic optics and on the position of the optical components with variable refractive power 7A, 7B in the beam path of the basic optics, so that a closed general solution cannot explicitly be given.

For more detailed description, some fundamental relationships which define the space of the solution according to the invention will be explained below, but without it being possible to give a general solution explicitly. With the teaching presented here, however, suitable solutions can easily be determined by the person skilled in the art of optics for any basic optics in question, according to generally known methods with the aid of an optical design program.

The following basic paraxial equations generally apply for a static optical system

$$\begin{matrix}S = {f}^{′} \cdot ( \frac{1}{{β}^{′}} - 1 ) & ( B1 ) \\ {S}^{′} = {f}^{′} \cdot ( 1 - {β}^{′} ) & ( B2 )\end{matrix}$$

Here, S is the distance from the object-side principal plane to the object plane, S′ is the distance from the image-side principal plane to the image plane, β′ is the lateral imaging scale and f′ is the focal length of the optical system. There is a requirement that β′=Const. should be satisfied. If this condition is introduced into the equation above and it is solved for f′, the following condition is obtained:

$${f}^{′} = \frac{S}{\frac{1}{{β}^{′}} - 1} \qquad ( B3 )$$

or, differentially:

$$Δ {f}^{′} = \frac{Δ S}{\frac{1}{{β}^{′}} - 1} \qquad ( B4 )$$

Here, ΔS is a change in the relative distance from the front principal plane to the object plane and Δf′ is a change in the system focal length.

Formally, Equation (B1) can be satisfied by a two-parameter solution manifold. On the one hand, it is possible to displace the object-side principal plane of the overall system by means of a refractive power change of the optical components with variable refractive power 7A, 7B, and on the other hand by a suitable refractive power adaptation of the optical components with variable refractive power 7A, 7B it is also possible to change the focal length of the overall system. Depending on the selected position of the optical components with variable refractive power 7A, 7B in the system, either one of these two limiting cases or a combination of the two cases may apply. The case which is respectively advantageous depends on the internal structure of the basic optics.

The limiting case that the object-side principal plane of the overall system is not changed will be considered by way of example. In this case, the value ΔS in Equation (B4) is to be equated directly with the change in the relative distance between the optical system and the object, and keeping the image size constant requires a refractive power or focal length adaptation Δf′ by means of the optical components with variable refractive power 7A, 7B, such that the system focal length f′ satisfies Equation (B3).

The refractive power adaptations of the variolenses which are required in order to change the system focal length according to Equation (B3) likewise depend on the position of the optical components with variable refractive power 7A, 7B relative to the beam path of the basic optical system. Generally, for a system of k refracting faces, the following relationship applies for the system focal length:

$${f}^{′} = \frac{1}{{\sum }_{v = 1}^{k} \frac{{h}_{v}}{{h}_{1}} \cdot {ϕ}_{v}} \qquad ( B5 )$$

Here, h is the incidence height of a paraxial marginal ray on the face v, h₁ is the incidence height of a paraxial marginal ray on the first face in the system and φᵥ is the face refractive power of the v-ten system surface.

For the lenses of the basic system, i.e. ones with a fixed (not adjustable) refractive power, each face refractive power φv satisfies the relationship:

$${ϕ}_{v} = \frac{{n}_{v}^{′} - {n}_{v}}{{r}_{v}} \qquad ( B6 )$$

where n and n′ are the media refractive indices before and after the refracting face and r is the radius of the principal curvature at the vertex of the face. For the optical components with variable refractive power 7A, 7B of the system, if they are embodied according to the invention by moving freeform elements 9, 11 according for example to Equation (A1), a face pair respectively corresponds to a face in the sense of the equation above and the face refractive power is given by the following formula:

φᵥ=4·k·s·(n−1) (B7)

Here, k is the constant according to the face Equation (A1), s is the lateral displacement path of the two freeform faces 9, 11 with respect to one another, and n is the refractive index of the glass from which the optical components with variable refractive power 7A, 7B are formed.

The second basic Equation (B2)

S′=f′·(1−β′)

describes the generally applicable relationship between the lateral imaging scale, the system focal length and the distance from the image-side principal plane to the image plane. In order to satisfy this equation, there is likewise a two-parameter solution which can be represented with the aid of two limiting cases:

On the one hand, with a given constant imaging scale and the new focal length f′ calculated according to Equation (B3), a displacement of the image-side principal plane may be carried out by the second degree of freedom for the adjustment of the at least two optical components with variable refractive power 7A, 7B. In this way, Equation (B2) can be satisfied by correspondingly changing S′ as the relative distance from the principal plane to the image plane, even though the image position relative to the image receiver, or the optical system, remains constant overall.

On the other hand, the image-side back focal distance, i.e. the position of the image plane relative to the image-side principal plane, may be adapted directly by the second degree of freedom, the position of the image-side principal plane itself remaining constant.

In general, an advantageous solution will need to be selected in such a way that the two basic cases explained above occur in superimposition.

Thus, even though it is also not possible to give a closed formula for the solution space of the solution according to the invention—as is virtually never possible in an optical design except in the most trivial of cases—through the description of the solution approach described above together with the optical programs generally available for solving such tasks, it is nevertheless possible for any person skilled in the art to find an embodiment of the solution according to the invention suitable for his relevant basic optics.

It is furthermore possible to produce the two optical components with variable refractive power 7A, 7B from different types of glass, or respectively to configure them as cemented elements consisting of different types of glass. This makes it possible to form the optical components with variable refractive power 7A, 7B as achromatic optical components.

In order to displace the freeform elements 9, 11 when inducing the refractive power change, the actuators 13, 15 must accelerate the respective elements. This, however, leads to forces which can in turn cause vibrations of the observation optics 3. In order to keep the movement of the freeform elements 9, 11 small, smoothing of the respective control signals may be carried out, so that the risk of exciting vibrations is reduced. Such smoothing may, in particular, be carried out by using the data contained in the movement signal regarding the movement between the observation optics 3 and the observation object 4 for fitting a parametric curve shape. In this case, in particular, a harmonic vibration may be used as a parametric curve shape. This is particularly suitable to ensure optical compensation for the vibration in vibrating systems, since it can be adapted particularly easily by means of a parameter fit to the shape of the vibration in question. After the control unit 17 has adapted the parameters, it can precalculate the future movement between the observation optics 3 and the observation object 4 and likewise the control movement of the freeform elements 9, 11 required in order to compensate for the precalculated movement. On the basis of the precalculated control movements, the time available for adjusting the respective position of the freeform elements 9, 11 can be extended, so that operation can be carried out with smaller accelerations. Besides the method described, there are other suitable mathematical methods which make it possible to create a parametric module with data smoothing on the basis of a discrete time sequence of acceleration values or position values. These are known to the person skilled in the art and will not therefore be explained in further detail here.

The image stabilization device, which is provided in the exemplary embodiment shown in FIG. 1, is however capable of compensating not only for movements parallel to the optical axis OA but also for movements perpendicular to the optical axis. To this end, the device in the present exemplary embodiment comprises a prism 29 having plane faces 30, 31, the attitude angle α of which is variably adjustable. By a suitable adjustment of the attitude angle α, the image position can be displaced laterally. Such elements are described, for example, in U.S. Pat. No. 5,140,462. Nevertheless, other optical elements with which a lateral image displacement can be achieved, for instance disposable lenses, mirrors mounted in a mobile fashion, etc., may also be used instead of the described prism 29. Such systems for the lateral displacement of an image are fundamentally known from the prior art and will not therefore be explained in further detail here.

The respectively required displacement of the image perpendicular to the optical axis OA is calculated by the control unit 17 from the movement data transmitted by the movement sensor regarding the movement between the observation optics 3 and the observation object 4 perpendicular to the optical axis OA. It then outputs a control signal to the prism 29, which represents the attitude angle α required in order to achieve the calculated image displacement.

Although the control of the prism 29 is undertaken in the present exemplary embodiment by the control unit 17, which also controls the optical subelements with variable refractive power 7A, 7B, for controlling the prism 29 there may also be a separate control unit which is likewise connected to the movement sensor 19 in order to receive the movement signal.

The control unit, or the control units, may consist of a microprocessor or microcontroller permanently built into the optical instrument in question, an electronics unit specially provided as a physical unit outside the optical instrument for this purpose, or software which runs on another external computer. If a control unit is provided outside the optical instrument, the control signals may in particular be transmitted wirelessly to the respective actuators. Although wire-bound communication is also possible, the cables needed for this may however be problematic for the user of the optical observation instrument, so that wireless transmission is preferred if it is possible.

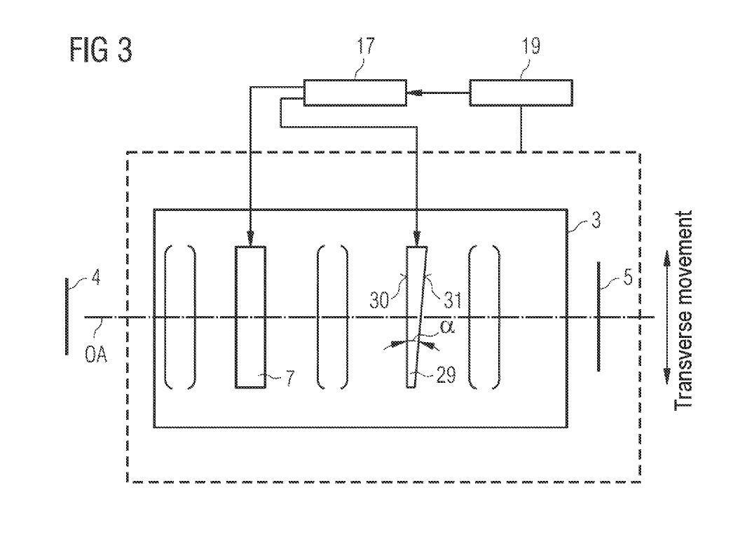

A variant of the exemplary embodiment represented in FIG. 1 is shown in FIG. 3. Elements of FIG. 3 which correspond to elements of the first exemplary embodiment are provided with the same references as denoted in FIG. 1 and will not be explained again in order to avoid repetition. Merely the differences from the exemplary embodiment represented in FIG. 1 will therefore be described.

The variant represented in FIG. 3 differs from the exemplary embodiment represented in FIG. 1 by the optical element with adjustable refractive power 7, which is used for optical compensation of the movements in the direction parallel to the optical axis OA. Instead of an optical element having two subelements respectively constructed from freeform elements, in the variant represented in FIG. 3 an elastopolymer lens 7 is used. Such a lens comprises at least one deformable membrane, which limits a pressure chamber. The membrane may constitute an outer face of the lens or an interface between two chambers, which contain media with different refractive indices. By means of a pressure change in one chamber, a curvature of the outer face or of the interface can be induced or modified. In the variant of the exemplary embodiment of FIG. 1, as represented in FIG. 3, instead of a displacement the control signal therefore represents at least one pressure which is to be applied to the elastopolymer lens 7.

As the optical observation instrument represented in FIG. 3 only contains an elastopolymer lens 7, although it is possible to compensate for blurring due to movements between the observation optics 3 and the observation object 4 along the optical axis OA, it is not possible to compensate for the changes in the image size which then occur. The lack of adaptation of the image size can lead to blurring in the marginal region of the image. Such blurring is often not a further problem since it generally lies outside the image region of interest (ROI). If they should have an interfering effect, however, in the variant shown in FIG. 3 it is also possible to provide a second elastopolymer lens in the beam path, in order to keep the image size constant as well.

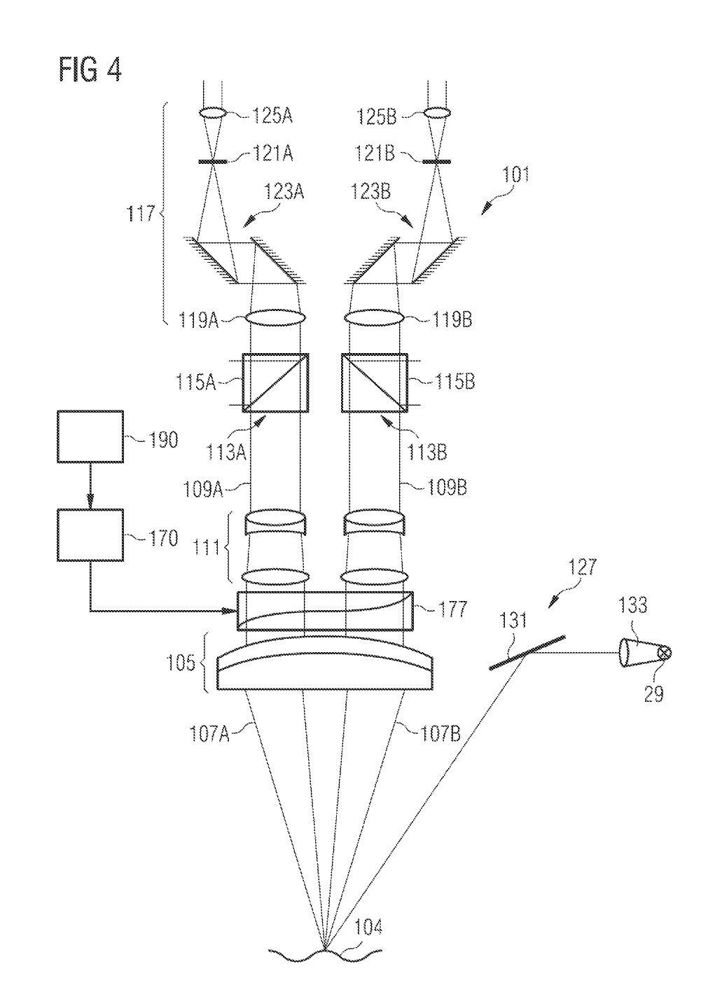

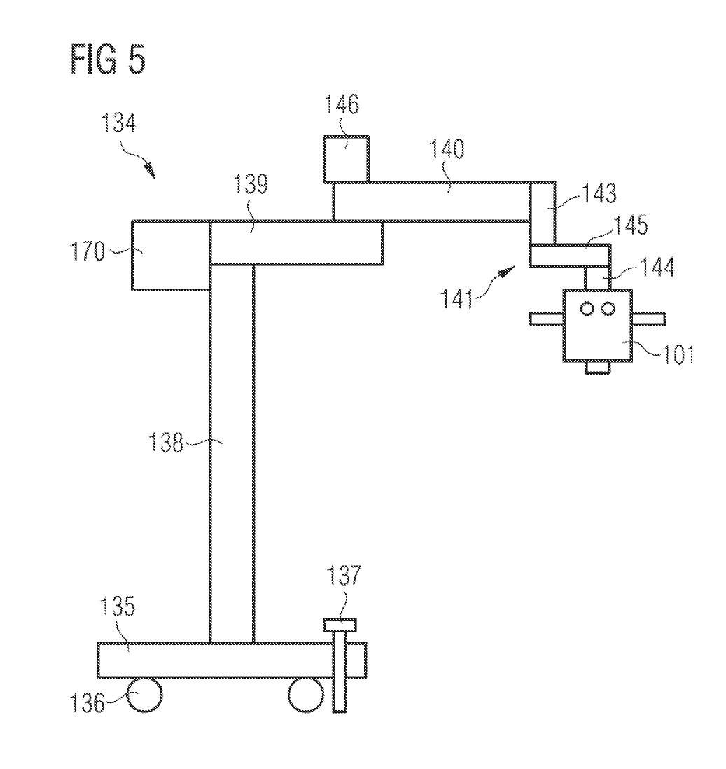

As a further exemplary embodiment of the optical observation instrument according to the invention, FIG. 4 shows an operation microscope 101 in a schematic representation. The operation microscope 101 represented comprises an objective 105, which is intended to face towards an observation object 104 and in the present exemplary embodiment is represented as an achromatic or apochromatic lens constructed from at least two sublenses cemented together. The observation object 104 is arranged in the focal plane of the objective 105, so that it is imaged at infinity, i.e. a divergent ray bundle 107 coming from the observation object 104 is converted into a parallel ray bundle 109 when it passes through the objective 105.

Instead of just one achromatic lens, as is used as the objective 105 in the present exemplary embodiment, it is also possible to use an objective lens system consisting of a plurality of individual lenses, for instance a so-called vario-objective with which the working distance of the operation microscope 101, i.e. the distance of the focal plane from the objective 105, can be varied. In such a vario-system as well, the tissue region 103 arranged in the focal plane is imaged at infinity, so that there is also a parallel ray bundle on the observer side in the case of a vario-system.

Arranged on the observer side of the objective 105, there is a magnification changer 111, which may be formed either as a zoom system for continuously changing the magnification factor, as in the exemplary embodiment represented, or as a so-called Galilean changer for changing the magnification factor in stages. In a zoom system, which is constructed for example from a lens combination comprising three lenses, the two lenses on the object side can be displaced in order to vary the magnification factor. In fact, however, the zoom system may also comprise more than three lenses, for example four or more lenses, in which case the outer lenses may also be arranged fixed. In a Galilean changer, on the other hand, there are a plurality of fixed lens combinations which represent different magnification factors and can alternatively be introduced into the beam path. Both a zoom system and a Galileo changer convert a parallel ray bundle on the object side into a parallel ray bundle on the observer side with a different bundle diameter. The magnification changer 111 is often already part of the binocular beam path of the operation microscope 101, i.e. it comprises a separate lens combination for each stereoscopic sub-beam path 109A, 109B of the operation microscope 101.

The magnification changer 111 may be followed on the observer side by an interface arrangement 113A, 113B, by means of which external instruments can be connected to the operation microscope 101 and which in the present exemplary embodiment comprises beam splitter prisms 115A, 115B. In principle, however, other types of beam splitters may also be used, for example semitransparent mirrors.

The interface 113 is followed on the observer side by a binocular tube 117. This comprises two tube objectives 119A, 119B which focus the respective parallel ray bundle 109A, 109B onto an intermediate image plane 121, i.e. they image the observation object 104 onto the respective intermediate image plane 121A, 121B. The intermediate images located in the intermediate image planes 121A, 121B are finally imaged at infinity again by eyepiece lenses 125A, 125B, so that an observer, for instance an attending doctor or his assistant, can observe the intermediate image with relaxed eyes. Furthermore, magnification of the distance between the two sub-ray bundles 109A, 109B is carried out in the binocular tube by means of a mirror system or by means of prisms 123A, 123B, in order to adapt them to the distance between the observer's eyes. Image rectification is also carried out by the mirror system or the prisms 133A, 133B.

The operation microscope 101 is furthermore equipped with an illumination device 127, by which the observation object 104 can be illuminated with illumination light. To this end, the illumination device 127 comprises a light source 129, for instance an incandescent halogen lamp, a gas discharge lamp, one or more LEDs, etc. The light coming from the light source 129 is directed by means of a deviated mirror 131 in the direction on the surface of the observation object 104, in order to illuminate it. The illumination device 127 furthermore contains illumination optics 133, which ensure uniform illumination of the entire observation object 104.

The illumination beam path may be configured as so-called oblique illumination, which most greatly resembles the schematic representation in FIG. 4. In such oblique illumination, the beam path extends at a relatively large angle (6° or more) with respect to the optical axis of the objective 105 and may, as represented in FIG. 4, extend entirely outside the objective 105. As an alternative, however, it is also possible to make the illumination beam path of the oblique illumination extend through a marginal region of the objective 105. Another possibility for the arrangement of the illumination beam path is so-called 0° illumination, in which the illumination beam path extends through the objective 105 and is coupled into the objective 105 between the two sub-beam paths 109A, 109B along the optical axis of the objective 105, in the direction of the observation object 104. Lastly, it is also possible to configure the illumination beam path as so-called coaxial illumination, in which there are a first and a second illumination sub-beam path. The sub-beam paths are coupled into the operation microscope by means of one or more beam splitters, parallel to the optical axes of the observation sub-beam paths 109A, 109B, so that the illumination extends coaxially with the two observation sub-beam paths.

The illumination device 127 may be arranged directly on the operation microscope 101 or at a distance from the operation microscope 101, for instance on the microscope stand. In the case of a remote arrangement, the light from the light source device is guided to the operation microscope 101 by means of a light guide.

The operation microscope 101 is held by a stand, such as is represented in FIG. 5. The stand 134, merely represented schematically in the figure, rests on a stand base 135, on the lower side of which there are rollers 136 which make it possible to move the stand 134. In order to prevent unintended movement of the stand 134, the stand base 135 furthermore has a footbrake 137.

The stand 134 per se comprises as stand members a height-adjustable stand column 138, a carrying arm 139, a spring arm 140 and a microscope suspension 141, which in turn comprises a connecting element 143, a swivel arm 145 and a holding arm 144. In the exemplary embodiment represented, a light source 146 for the object illumination is furthermore arranged on the stand 134. When movements of the operation microscope take place in a direction parallel to the optical axis, for example on the basis of vibrations, the distance of the objective 105 from the observation object 104 changes, so that the observation object 104 can migrate out of the focal plane, which may lead to blurring in the image representation.

The stand 134 constitutes a vibratable system, the spring arm 140 in particular being susceptible to vibrations in the stand represented in FIG. 5. Such vibrations lead to position displacements of the operation microscope 101. In order in particular to be able to optically compensate for position displacements in the direction of the optical axis of the operation microscope 101, in the present exemplary embodiment, as an optical element with adjustable refractive power 177 an element comprising two freeform elements 9, 11 is arranged behind the primary objective 105.

In order to move the two freeform elements 9, 11, two actuators (not shown) are provided which can rapidly displace the corresponding masses of the freeform elements 9, 11. For example, piezo elements may be provided. Rapid displacement of the masses, however, entails the risk that vibrations will in turn be excited by the optical compensation itself, for which reason particular attention must be paid to the smoothing of the control movement.

The use of other optical elements with adjustable refractive power in operation microscopes is not, however, precluded. For example, a liquid crystal lens may be used instead of the freeform elements 9, 11. In liquid crystal lenses (LC lenses), the refractive index of the liquid crystals depends on their orientation. The orientation can in turn be influenced by applying a suitable voltage. By means of voltage signals, it is therefore possible to vary the refractive power of the liquid crystal lens. The control signal, output by the control unit 170 in the present exemplary embodiment, then represents a voltage to be applied to the liquid crystal lens instead of a displacement of freeform elements perpendicular to the optical axis.

Varying the refractive power by applied voltages offers the advantage that relevant masses are not moved, so that very rapid adjustment of the required refractive force can take place. This can be advantageous particularly in the case of stereo microscopes in which time-sequential digital imaging takes place, since in this case the available exposure time is very short. Vibrations which act within an exposure therefore generally have a high frequency, which also necessitates compensation with a high frequency.

In the present exemplary embodiment, the control unit 170 is arranged on the stand. Control signals are conducted from the control unit 170 by cable through the stand to the operation microscope 101, where they are likewise forwarded by cable to the actuators assigned to the freeform elements 9, 11. Conducting the control signals to the actuators by cable is advantageous, particularly in the case of operation microscopes, since it is often not possible to use radio transmitters in operating theatres because this would interfere with other medical instruments. Transmission by means of infrared signals is difficult to carry out, since to this end a receiver would have to lie in the direct field of view of the transmitter. Although the latter could be fitted on the outside of the operation microscope, cables are generally already fed through the stand in any case, so that it is in general readily possible to feed a cable for transmitting the control signals through the stand as well.

As in other exemplary embodiments, the movement sensor 190 may either be an acceleration sensor arranged on the microscope, in particular arranged on its observation optics, or a position sensor for example based on time-of-flight measurement and triangulation. An acceleration sensor is advantageous insofar as by integration the movement speeds, and by further integration the future positions, can be precalculated from the acceleration. In the case of a position sensor, on the other hand, it is only from a recorded time series of positions that the acceleration value can be determined, from which future speeds and positions can then in turn be estimated. Use of the acceleration sensor is advantageous insofar as the acceleration data are provided directly, which reduces the computation outlay in the control unit.

Besides the at least one optical element 7 with adjustable refractive power, the operation microscope 101 may also comprise an optical element with which a lateral image displacement can be achieved, so that optical compensation for three-dimensional movements is possible.

The present invention has been explained in detail with the aid of exemplary embodiments for illustration purposes. The exemplary embodiments may, however, be modified. For example, in the operation microscope described with reference to FIGS. 4 and 5, it is also possible to provide an optical element comprising at least two subelements, the refractive indices of which are adjustable, in order to keep the image size constant as well. If two such components are used in an exemplary embodiment, these may respectively be formed identically. It is, however, also possible in all exemplary embodiments to use two optical subelements with variable refractive index which are based on different principles; for example, freeform elements may be combined with liquid crystal lenses or elastopolymer lenses. Furthermore, besides the types of lenses mentioned and the freeform elements, there are other optical elements whose refractive index can be influenced. For example, it is possible to use liquid lenses based on the electrocapillary effect, in the case of which an electrical voltage changes a wetting angle and generates a spherical interface between two liquids having different refractive indices. Furthermore, the invention is not intended to be restricted to cameras, in particular macrocameras or operation microscopes. It may, for example, likewise be used in the scope of optical measurement heads. It is likewise possible for the observation optics to be optics for observation in the infrared or ultraviolet spectral ranges. In the former case all the elements, including the optical elements with adjustable refractive power, will be constructed from an infrared-transmitting material, for example silicon or germanium. In the latter case, a UV-transmitting material will be used, for example Suprasil or quartz. The present invention is therefore not intended to be restricted to the exemplary embodiments. Rather, the protective scope is intended to be defined by the appended claims.

The invention, explained in detail with the aid of specific exemplary embodiments, makes it possible to compensate sufficiently rapidly for the effect of typical unintentional longitudinal movements such as the vibration of stands or the trembling of hands.

What is claimed is:

1. Method for image stabilization in an optical observation or measurement instrument (1, 101) comprising observation optics (3) which have an optical axis (OA) and at least one optical element with adjustable refractive power (7, 7A, 7B, 177), an unintended movement taking place between the observation optics (3) and an observation object (4) along the optical axis (OA), wherein optical compensation for the unintended movement along the optical axis (OA) is carried out in that:
the movement along the optical axis (OA) is determined,
on the basis of the movement determined, at least one control variable for the adjustable optical element (7, 7A, 7B, 177) is determined, which represents the refractive power of the at least one optical element with adjustable refractive power (7, 7A, 7B, 177) necessary for optical compensation for the movement along the optical axis (OA), and
an adjustment of the at least one optical element with adjustable refractive power (7, 7A, 7B, 177) is carried out on the basis of the at least one control variable.

2. Method according to claim 1, wherein the movement results from a movement of the observation optics (3) and the movement speed of the observation optics (3) or the acceleration of the observation optics (3) is determined, and the movement of the observation optics (3) is determined from the movement speed determined or the acceleration determined.

3. Method according to claim 1, wherein the determination of the movement of the observation optics (3), the determination of the at least one control variable and the adjustment of the at least one optical element with adjustable refractive power (7, 7A, 7B, 177) are carried out repeatedly.

4. Method according to claim 3, wherein the at least one optical element with adjustable refractive power (7, 7A, 7B, 177) executes a control movement during the adjustment of the refractive power, and smoothing of the at least one control variable is carried out which leads to a minimization of the acceleration forces occurring during the control movement.

5. Method according to claim 4, wherein the smoothing is carried out in that a parameterized function is fitted with the aid of the at least one repeatedly determined control variable, and the adjustment of the at least one optical element with adjustable refractive power (7, 7A, 7B, 177) is carried out with the aid of the parameterized function obtained on the basis of the at least one control variable.

6. Method according to claim 1, wherein position changes to be expected between the observation optics (3) and the observation object (4) are precalculated with the aid of the determined movement along the optical axis (OA), and the at least one control variable is determined with a view to the position changes to be expected.

7. Method according to claim 1, wherein the optical element with adjustable refractive power comprises at least two optical subelements (7, 7A, 7B), the refractive powers of which can be adjusted independently of one another, the optical compensation for the movement along the optical axis (OA) being carried out by determining at least one control variable for each of the optical subelements with adjustable refractive power (7, 7A, 7B) on the basis of the movement determined, and an adjustment of the refractive powers of the optical subelements (7A, 7B) being carried out on the basis of the respective control variable or the respective control variables.

8. Method according to claim 1, wherein determination and compensation for a movement between the observation optics (3) and the observation object (4) perpendicularly to the optical axis (OA) of the observation optics (3) are furthermore carried out.

9. Device for image stabilization in an optical observation or measurement instrument comprising observation optics (3) which have an optical axis (OA), an unintended movement being capable of taking place between the observation optics (3) and an observation object (4) along the optical axis (OA), the image stabilization device comprising:
an optical element with adjustable refractive power (7, 7A, 7B, 177) which is to be arranged in the beam path of the observation optics (3) and is capable of optically compensating for an unintended movement along the optical axis (OA) with the aid of a change in its refractive power in response to at least one control signal,
a movement sensor (19) which records the movement along the optical axis (OA) and outputs a movement signal representing the movement; and
a control unit (17) which is connected to the movement sensor (19) in order to receive the movement signal and is connected to the at least one optical element with adjustable refractive power (7, 7A, 7B, 177) in order to output the at least one control signal, the at least one control signal representing the refractive power (7, 7A, 7B, 177) of the at least one optical element with adjustable refractive power, which is necessary for optical compensation for the movement along the optical axis (OA), and the control unit (17) determining the at least one control signal on the basis of the movement determined.

10. Device according to claim 9, wherein the optical element with adjustable refractive power (7A, 7B) comprises at least two freeform elements (9, 11) which can be moved relative to one another in a direction perpendicular to the optical axis (OA), and the at least one control signal represents the position of the freeform elements (9, 11) perpendicularly to the optical axis (OA).

11. Device according to claim 9, wherein the optical element with adjustable refractive power comprises a liquid crystal lens (177) or a liquid lens based on the electrocapillary effect, and in that at least one control signal represents a voltage to be applied to the liquid crystal lens (177) or liquid lens.

12. Device according to claim 9, wherein the optical element with adjustable refractive power comprises a membrane lens (7), and in that at least one control signal represents a pressure to be set up in the membrane lens (7).

13. Device according to claim 9, wherein the optical element with adjustable refractive power to be arranged in the beam path of the observation optics (3) comprises at least two optical subelements (7A, 7B), the refractive powers of which can be adjusted independently of one another.

14. Device according to claim 9, which furthermore comprises at least one instrument to be arranged in or on the observation optics (3) to compensate for a movement between the observation optics (3) and the observation object (4) perpendicularly to the optical axis (OA).

15. Optical observation instrument having observation optics and an image stabilization device according to claim 9.

16. Optical measurement instrument having observation optics and an image stabilization device according to claim 9.
